(19) United States
(12) Patent Application Publication
(10) Pub. No.: US 2003/0071601 A1
(43) Pub. Date: Apr. 17, 2003

(54) Power converter circuit having a pair of inversely coupled inductors

(75) Inventors: Chin Chang, Yorktown Heights, NY (US); Jingquan Chen, Boulder, CO (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/977,712

(22) Filed: Oct. 15, 2001

(51) Int. Cl. G05F 1/12

(52) U.S. Cl. 323/247

(57) ABSTRACT

A power converter circuit having an inversely inductively coupled structure is disclosed. The inversely inductively coupled structure having a primary coil and a second coil wound around a core. As such, primary magnetic flux lines are generated by a primary alternating current flowing through the primary coil and secondary magnetic flux lines are generated by a secondary alternating current flowing through the secondary coil. The result is a mutual inductance of the primary coil and the secondary coil. The primary magnetic flux lines flow through the core in a direction diametrically opposing a direction in which the secondary magnetic flux lines flow through the core. Consequently, the flux swing within the core is minimized.

### BACKGROUND OF THE INVENTION

1. Field of the Invention

The present invention generally relates to power converter circuits. The present invention specifically relates to the coupling of inductors wound around a core.

2. Description of the Related Art

FIGS. 1A-1B illustrate a structural arrangement of a power converter circuit as known in the art. The power converter circuit has a primary side including a power source interface 10 (e.g., a rectifier bridge of diodes), a primary coil L₁, and an electric switch 11 (e.g., a power field effect transistor). Primary coil L₁ has an input lead (represented by the phase dot) coupled to power source interface 10 and an output lead coupled to electric switch 11. Power source interface 10 and electric switch 11 are coupled to a common reference CREF.

Power source interface 10 received an alternating supply voltage V_{SS1} and an alternating supply current I_{SS1} from an external power source (not shown)(e.g., a wall socket). Electric switch 11 is biased into a conductive stage by a biasing voltage V_{B1} from an external controller (not shown). As a result, power source interface 10 provide an primary alternating current I₁ that flows through coil L₁ whereby an primary alternating voltage V₁ is applied between the input lead and the output lead of coil L₁.

The power converter further includes a core 30 with primary coil L₁ being wound around core 30. In response to primary alternating current 11, primary coil L₁ induces a primary magnetic field having alternating magnetic flux lines 12 flowing through core 30 as well as magnetic flux lines (not shown) adjacent core 30. The alternating magnetic flux lines 12 flow in a direction 13a (FIG. 1A) when primary alternating current 11 is experiencing a positive half cycle as illustrated in FIG. 2. The magnetic alternating flux lines 12 flow in a direction 13b (FIG. 1B) when primary alternating current 11 is experiencing a negative half cycle as illustrated in FIG. 2.

The power converter circuit has a secondary side including a power source interface 20 (e.g., a rectifier bridge of diodes), a secondary coil L₂, and an electric switch 21 (e.g., a power field effect transistor). Secondary coil L₂ has an input lead (represented by the phase dot) coupled to power source interface 20 and an output lead coupled to electric switch 21. Power source interface 20 and electric switch 21 are coupled to a common reference CREF.

Power source interface 20 received an alternating supply voltage V_{SS2} and an alternating supply current I_{SS2} from an external power source (not shown)(e.g., a wall socket). Electric switch 11 is biased into a conductive stage by a biasing voltage V_{B2} from an external controller (not shown). As a result, power source interface 20 provide an secondary alternating current 12 that flows through coil L₂ whereby an secondary alternating voltage V₂ is applied between the input lead and the output lead of coil L₂.

The power converter further includes a core 30 with secondary coil L₂ being wound around core 30. In response to a secondary alternating current I₂, secondary coil L₂ induces a secondary magnetic field having alternating magnetic flux lines 22 flowing through core 30 as well as magnetic flux lines (not shown) adjacent core 30. The alternating magnetic flux lines 22 flow in a direction 23a (FIG. 1A) when secondary alternating current 12 is experiencing a positive half cycle as illustrated in FIG. 2. The alternating magnetic flux lines 22 flow in a direction 23b (FIG. 1B) when secondary alternating current 12 is experiencing a negative half cycle as illustrated in FIG. 2.

Primary coil L₁, core 30, and secondary coil L₂ constitute an inductively coupled inductor structure of the power converter circuit due to the mutual inductance of primary coil L₁ and second coil L₂ established by the primary magnetic field and the secondary magnetic field. An equivalent model of the coupled inductor structure is illustrated in FIG. 3. The equivalent model has a primary side including an primary alternating voltage source that is representative of primary alternating voltage V₁ as well as a primary leakage inductor Lₑ₁, a magnetic inductor Lₘ, and primary coil L₁. The equivalent model also has a secondary side including an secondary alternating voltage source that is representative of secondary alternating voltage V₂ as well as a secondary leakage inductor Lₑ₂ and secondary coil L₂.

By properly selecting the primary/secondary turns ratio 1:n of primary coil L₁ and second coil L₂ in accordance with a leakage inductance and a magnetic inductance of the coupled inductor structure, a desirable zero ripple current condition could happen to the primary side or the secondary side of the coupled inductor structure. The ripple current at the primary side tends to be zero under the following equation [1]:

Lₑ₂=(1−N)★N★Lₘ [1]

The ripple current at the secondary side tends to be zero under the following equation [2]:

Lₑ₂=(N−1)★Lₘ [2]

However, an operation of the coupled inductor structure results in a flux swing in core 30 that is enhanced due to the equivalence of the alternating polarity of primary magnetic flux lines 12 within core 30 as shown in FIGS. 1A and 1B and the alternating polarity of second magnetic flux lines 22 within core 30 as shown in FIGS. 1A and 1B. Consequently, core 30 experiences significant core losses. Traditionally, a size and a cross-sectional area of core 30 are selected to minimize core losses experienced by core 30 as much as possible while preventing magnetic saturation of core 30. Unfortunately, the size and the cross-sectional area of core 30 needed to minimize the core losses of core 30 and to prevent magnetic saturation of core 30 may not be practical in terms of an incorporation of the power converter circuit of FIGS. 1A and 1B within various systems.

The present invention addresses this problem.

### SUMMARY OF THE INVENTION

The present invention relates to a power converter circuit having a pair of inversely coupled inductors. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

The present invention is a power converter circuit comprising a core, a primary coil, and a secondary coil. The primary coil is operable to induce a plurality of primary alternating magnetic flux lines flowing through the core in response to a primary alternating current flowing through the primary coil. The secondary coil is operable to induce a plurality of secondary alternating magnetic flux lines flowing through the core in response to a secondary alternating current flowing through the secondary coil. The primary alternating magnetic flux lines and the secondary alternating magnetic flux lines collectively produce a flux swing within the core.

In one form of the present invention, the primary coil and the secondary coil are inversely inductively coupled whereby the flux swing is minimized.

In a second form of the present invention, a directional flow of the primary magnetic flux lines within said core diametrically oppose a directional flow of alternating magnetic flux lines within said core whereby the flux swing is minimized.

In a third form of the present invention, the primary alternating magnetic flux lines and the secondary alternating magnetic flux lines establish an inductance of the primary coil and the secondary coil whereby the flux swing is minimized.

The foregoing forms and other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1A illustrates a power converter circuit as known in the art with a primary current, a primary voltage, a secondary current and a secondary voltage experiencing a positive half cycle;

FIG. 1B illustrates the FIG. 1A power converter circuit as known in the art with a primary current, a primary voltage, a secondary current and a secondary voltage experiencing a negative half cycle;

FIG. 2 illustrates duty cycles of a primary current, a primary voltage, a secondary current and a secondary voltage of the FIGS. 1A and 1B power converter circuit;

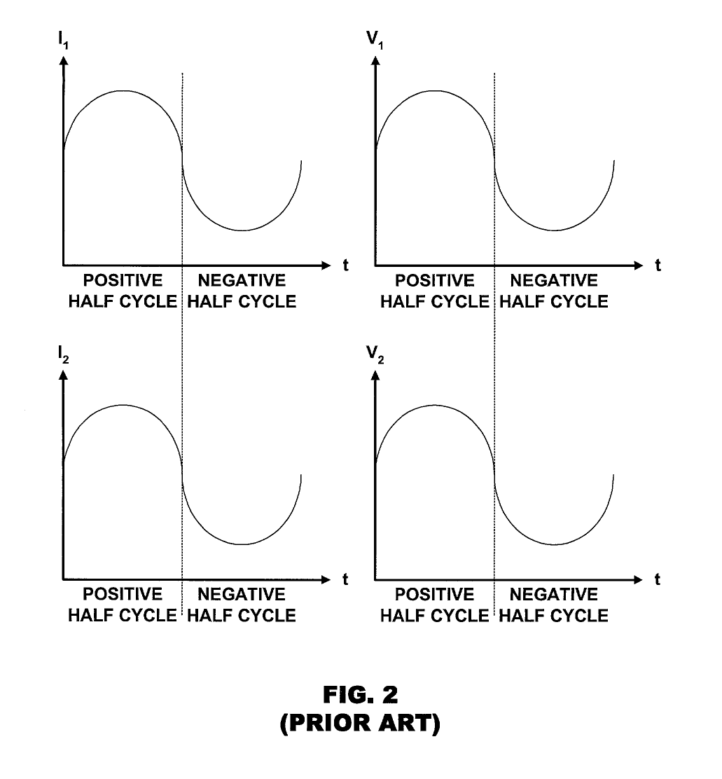

FIG. 3 illustrates a schematic diagram of an equivalent model of a coupled inductor structure of the FIGS. 1A and 1B power converter circuit;

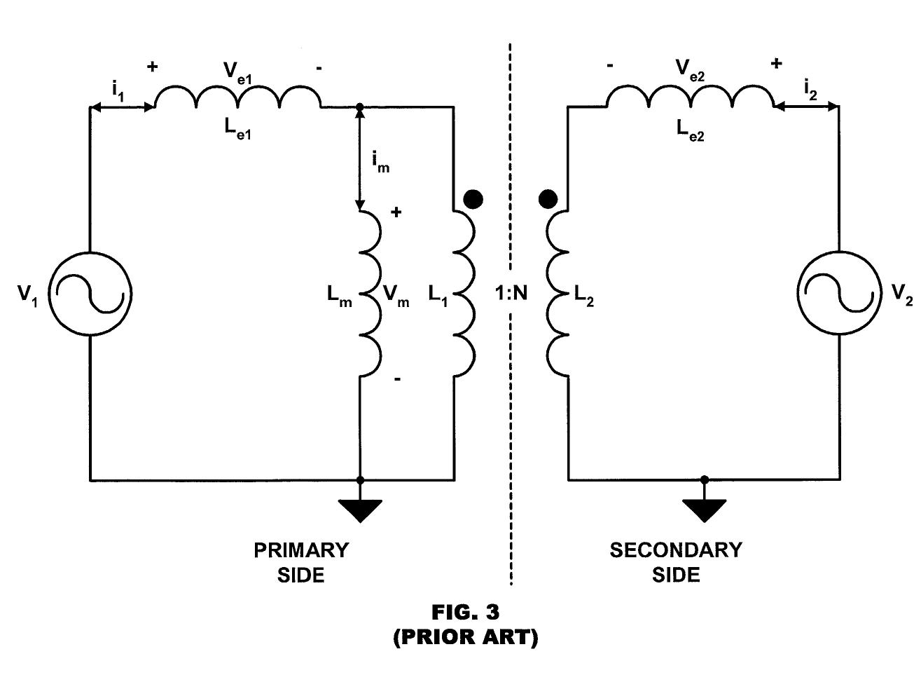

FIG. 4A illustrates a power converter circuit as known in the art with a primary current and a primary voltage experiencing a positive half cycle, and a secondary current and a secondary voltage experiencing a negative half cycle;

FIG. 4B illustrates the FIG. 4A power converter circuit as known in the art a primary current and a primary voltage experiencing a negative half cycle, and a secondary current and a secondary voltage experiencing a positive half cycle;

FIG. 5 illustrates duty cycles of a primary current, a primary voltage, a secondary current and a secondary voltage of the FIGS. 4A and 4B power converter circuit; and

FIG. 6 illustrates a schematic diagram of an equivalent model of an inversely coupled inductor structure of the FIGS. 4A and 4B power converter circuit.

### DETAILED DESCRIPTION OF THE PRESENTLY PREFERRED EMBODIMENTS

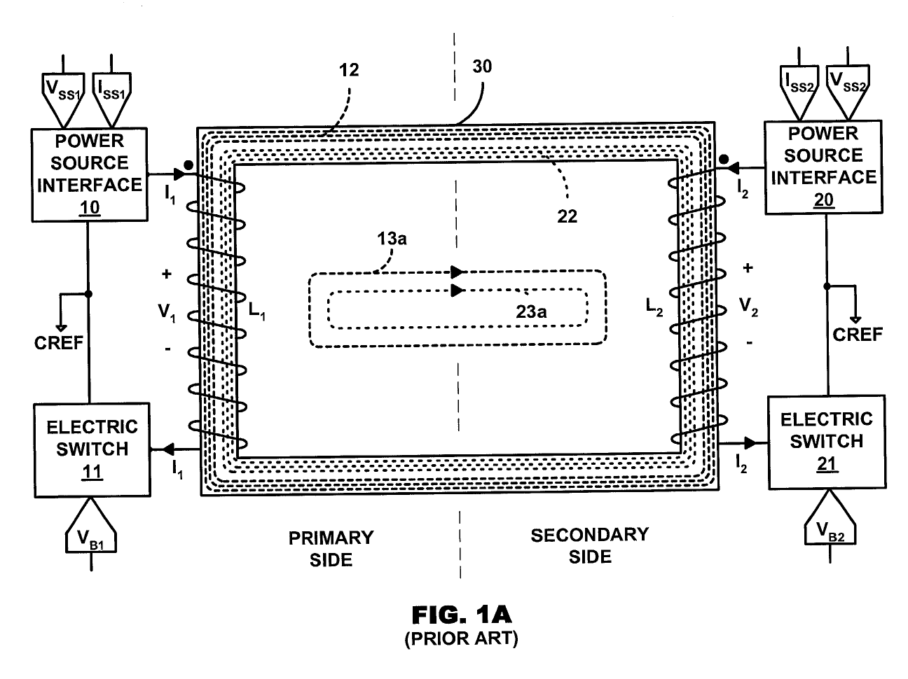

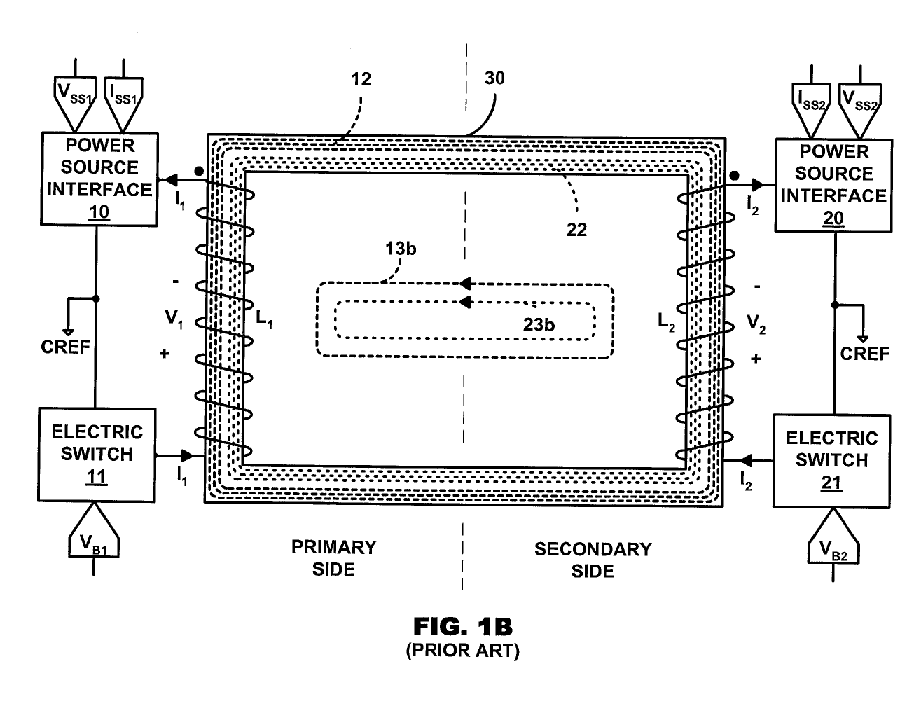

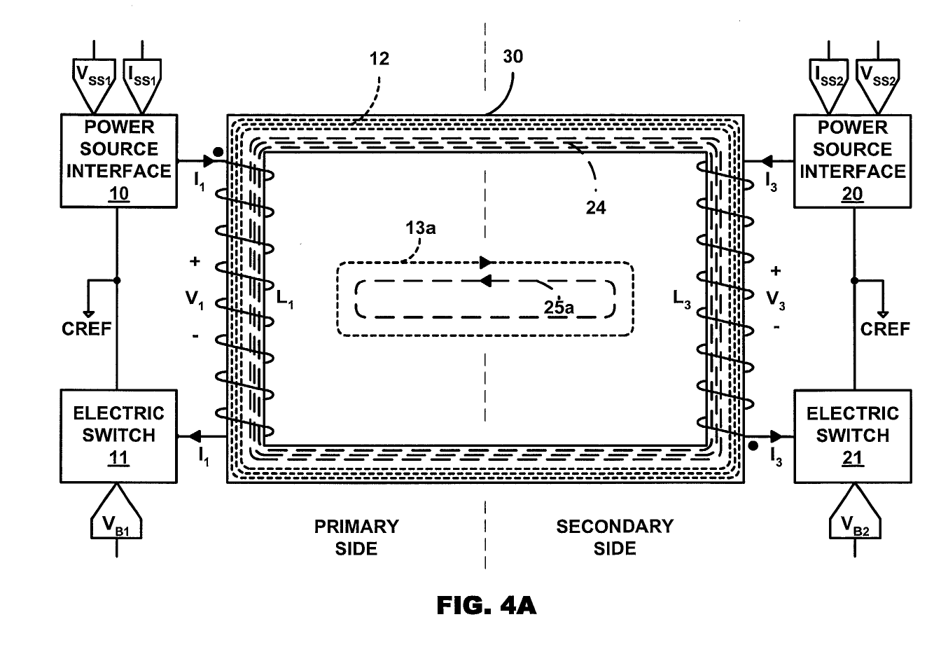

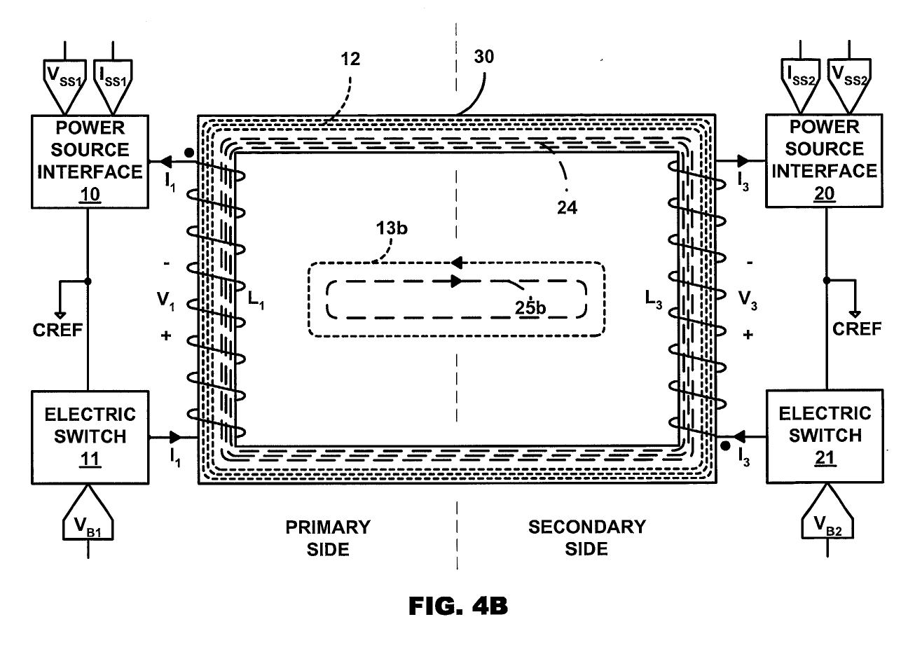

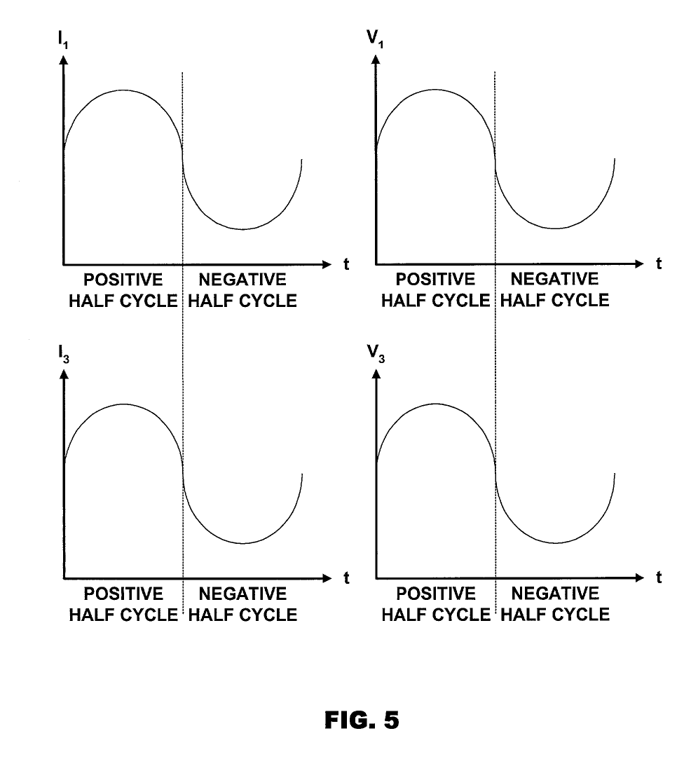

FIGS. 4A and 4B illustrate a power converter circuit in accordance with the present invention. The power converter circuit of the present invention has a primary side that is identical to the primary side of the prior art power converter circuit shown in FIGS. 1A and 1B. The power converter circuit of the present invention further has a secondary side that is similar to the secondary side of the prior art power converter circuit shown in FIGS. 1A and 1B with the exception of a secondary coil L₃ in lieu of secondary coil L₂. Secondary coil L₃ is wound around core 30 in a direction diametrically opposing the direction that secondary coil L₁ (FIGS. 1A and 1B) is wound around core 30. An input lead of secondary coil L₃ (as represented by the phase dot) is coupled to electric switch 21 and the output lead of secondary coil L₃ is coupled to power source interface 20. A secondary alternating current i₃ flowing through secondary coil L₃ is in phase with primary alternating current I₁ as shown in FIG. 5, and a secondary alternating voltage V₃ applied between the input lead and the output lead of secondary coil L₃ is in phase with primary alternating voltage V₁ as illustrated in FIG. 5.

The flowing of secondary alternating current I₃ through secondary coil L₃ also induces a secondary magnetic field having magnetic flux lines 24 flowing through core 30 as well as magnetic flux lines (not shown) flowing adjacent core 30. The magnetic flux lines 24 flow in a direction 25a (FIG. 4A) when secondary alternating current I₃ is experiencing a positive half cycle as illustrated in FIG. 5. The magnetic flux lines 24 flow in a direction 25b (FIG. 4B) when secondary alternating current I₃ is experiencing a negative half cycle as illustrated in FIG. 5. As shown in FIGS. 4A and 4B, primary magnetic flux lines 12 diametrically oppose secondary magnetic flux lines 24 to thereby minimize the flux swing within core 30, in particular when a magnitude of primary magnetic flux lines 12 equals a magnitude of secondary magnetic flux lines 24.

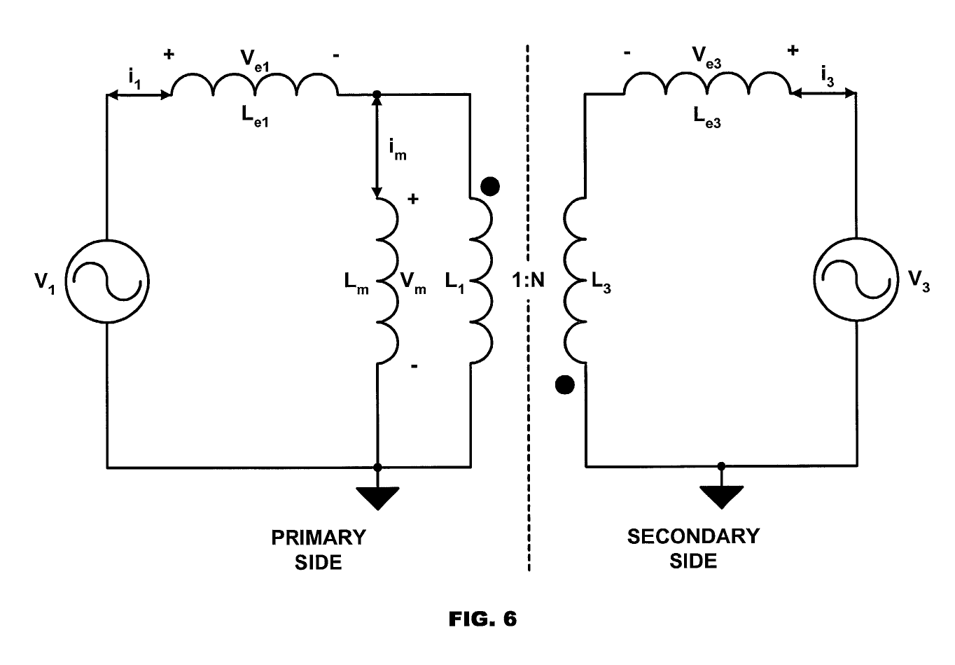

Primary coil L₁, core 30, and secondary coil L₂ constitute an inversely coupled inductor structure of the power converter due to the mutual inductance of primary coil L₁ and second coil L₂ established by the primary magnetic field and the secondary magnetic field. An equivalent model of the inversely coupled inductor structure is illustrated in FIG. 6. The equivalent model has a primary side including a primary alternating voltage source that is representative of primary alternating voltage V₁ as well as a primary leakage inductor Lₑ₁, a magnetic inductor Lₘ, and primary coil L₁. The equivalent model also has a secondary side including a secondary alternating voltage source that is representative of secondary alternating voltage V₃ as well as a secondary leakage inductor Lₑ₃ and secondary coil L₃.

The following equation [3] is derived from the equivalent model of the inversely coupled inductor structure based upon primary alternating voltage V₁ and secondary alternating voltage V₃ being in phase:

$$- [ {L}_{e1} + ( ( n + 1 ) {L}_{M} ) ] \frac{ⅆ {i}_{1} ( t )}{ⅆ t} = [ {L}_{e3} + ( ( n + 1 ) {nL}_{M} ) ] \frac{ⅆ {i}_{3} ( t )}{ⅆ t} \qquad [ 3 ]$$

Lₑ₁ and L_{M} physically exist, and therefore have positive values. Thus, the ideal zero ripple steering condition represented by equations [1] and [2] is not satisfied. However, the following equation [4] illustrates a relationship between magnetizing current I_{M} and leakage current I₁ and I₃:

$$\frac{ⅆ {i}_{m} ( t )}{ⅆ t} = ( \frac{{L}_{e3} - {nL}_{e1}}{{L}_{e3} + ( n + 1 ) {nL}_{M}} ) \frac{ⅆ {i}_{1} ( t )}{ⅆ t} = ( \frac{{nL}_{e1} - {L}_{e3}}{{L}_{e1} + ( n + 1 ) {L}_{M}} ) \frac{ⅆ {i}_{3} ( t )}{ⅆ t} \qquad [ 4 ]$$

From the above equation [4], if Lₑ₂=nLₑ₁, then diₘ(t)/dt=0. Thus, the ripple current in the magnetizing inductance is zero. In practice, however, the ideal condition of diₘ(t)/dt=0 is not suggested. The inversely coupled inductive structure is therefore designed whereby diₘ(t)/dt 0. The results are minimized flux swings within core 30 that lead to insignificant core losses.

The terminal characteristics of the inversely coupled inductor structure of primary coil L₁, core 30, and secondary coil L₂ are further derived from the following equations [5] and [6]:

$$\begin{matrix}{V}_{1} ( t ) = ( \frac{{L}_{e1} {L}_{e3} + {L}_{M} {L}_{e3} + {n}^{2} {L}_{M} {L}_{e1}}{{L}_{e3} + n ( n + 1 ) {L}_{M}} ) \frac{ⅆ {i}_{1} ( t )}{ⅆ t} = {L}_{eq1} \frac{ⅆ {i}_{1} ( t )}{ⅆ t} & [ 5 ] \\ {V}_{3} ( t ) = ( \frac{{L}_{e1} L3 + {L}_{M} {L}_{e3} + {n}^{2} {L}_{M} {L}_{e1}}{{L}_{e3} + ( n + 1 ) {L}_{M}} ) \frac{ⅆ {i}_{3} ( t )}{ⅆ t} = {L}_{eq2} \frac{ⅆ {i}_{3} ( t )}{ⅆ t} & [ 6 ]\end{matrix}$$

By properly selecting the primary/secondary turns ratio 1:N of primary coil L₁ and secondary coil L₂ in accordance with a leakage inductance and a magnetic inductance of the coupled inductor structure, the desirable small ripple current could happen to the primary side of the coupled inductor structure or the secondary side of the coupled inductor structure can be achieved.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

What is claimed is:

1. A power converter circuit, comprising:
a core;
a primary coil operable to induce a plurality of primary magnetic flux lines flowing through said core in response to a primary alternating current flowing through said primary coil;
a secondary coil operable to induce a plurality of secondary magnetic flux lines flowing through said core in response to a secondary alternating current flowing through said secondary coil to thereby inductively couple said primary coil and said secondary coil;
wherein the primary magnetic flux lines and the secondary magnetic flux lines collectively produce a flux swing within said core; and
wherein said primary coil and said secondary coil are inversely inductively coupled whereby the flux swing is minimized.

2. A power converter circuit, comprising:
a core;
a primary coil operable to induce a plurality of primary magnetic flux lines flowing through said core in response to a primary alternating current flowing through said primary coil;
a secondary coil operable to induce a plurality of secondary magnetic flux lines flowing through said core in response to a secondary alternating current flowing through said secondary coil;
wherein the primary magnetic flux lines and the secondary magnetic flux lines collectively produce a flux swing within said core; and
wherein a directional flow of the primary magnetic flux lines within said core diametrically oppose a directional flow of the secondary magnetic flux lines within said core whereby the flux swing is minimized.

3. A power converter circuit, comprising:
a core;
a primary coil operable to induce a plurality of primary magnetic flux lines flowing through said core in response to a primary alternating current flowing through said primary coil; a secondary coil operable to induce a plurality of secondary magnetic flux lines flowing through said core in response to a secondary alternating current flowing through said secondary coil;
wherein the primary magnetic flux lines and the secondary magnetic flux lines collectively produce a flux swing within said core; and
wherein the primary magnetic flux lines and the secondary magnetic flux lines establish a mutual inductance of said primary coil and said secondary coil whereby the flux swing is minimized.
